(19) United States
(12) Patent Application Publication
(10) Pub. No.: US 2009/0243554 A1
(43) Pub. Date: Oct. 1, 2009

(54) Method of protecting battery for hybrid vehicle

(75) Inventors: Jae Sung Gu, Gyeonggi-do (KR); Suk Hyung Kim, Gyeonggi-do (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Kia Motors Corporation, Seoul (KR)

(21) Appl. No.: 12/228,737

(22) Filed: Aug. 15, 2008

(30) Foreign Application Priority Data
Mar. 27, 2008 (KR) 10-2008-0028142

(51) Int. Cl. H02J 7/18; H02H 7/18

(52) U.S. Cl. 320/162

(57) ABSTRACT

The present invention provides a method of protecting a battery for a hybrid vehicle, in which a counter electromotive voltage of a motor is limited by limiting engine RPM if it is determined that there is a risk of battery overcharge in the event of a failure of a component related to motor control, such as a motor controller, a battery controller, etc., thus protecting the battery from the risk of overcharge and securing safety of the battery.

### CROSS-REFERENCE TO RELATED APPLICATION

This application claims under 35 U.S.C. §119(a) the benefit of Korean Patent Application No. 10-2008-0028142 filed Mar. 27, 2008, the entire contents of which are incorporated herein by reference.

### BACKGROUND

(a) Technical Field

The present invention relates to a method of protecting a battery for a hybrid vehicle. More particularly, the present invention relates to a method of protecting a battery from the risk of overcharge in the event of a failure of a component related to motor control in a hybrid vehicle.

(b) Background Art

In general, a hybrid vehicle is driven by combining at least two different types of power sources and is directed to a hybrid electric vehicle (HEV) driven by an engine and an electric motor.

To meet the demands of today's society for improved fuel efficiency and the development of a more environmentally friendly product, research into hybrid electric vehicles is being actively conducted.

The hybrid vehicles are classified into a series hybrid vehicle, a parallel hybrid vehicle, and a series-parallel hybrid vehicle according to power transmission methods, and also classified into a soft HEV, a middle HEV, and a hard HEV according to power distribution ratios.

The series hybrid vehicle has a structure similar to that of an ordinary electric vehicle, in which the driving force is all obtained from an electric motor, and an engine is provided only for the purpose of generating electricity, thus improving the drawback of the electric vehicle having a short driving distance.

The parallel hybrid vehicle is driven primarily by the engine and the driving force is supplemented by the electric motor during driving at low speed where the engine efficiency is low or during acceleration.

Since the parallel hybrid vehicle is driven in an efficient operation range of the engine and the electric motor, the efficiency of the overall drive system is increased. Moreover, during braking, power is recovered by the electric motor to improve fuel efficiency.

In other words, the hybrid vehicles are classified into the series hybrid vehicle, in which a power generator is driven by the engine and the motor is driven by power from the generator, and the parallel hybrid vehicle, in which the engine is assisted by the motor to reduce the load of the engine.

The driving control method of the parallel hybrid vehicle includes an acceleration mode, a cruise mode, and a deceleration mode. During cranking of the engine, the cranking is performed by the engine, and during the acceleration mode, electrical energy is used to assist the driving force.

In the hybrid vehicle, a high-voltage battery for providing a relatively high voltage of about 500 V for example, is provided to drive the vehicle, and a low-voltage battery for storing a direct current power of a relatively low voltage of about 24 V for example, is provided for operation of vehicle electrical parts.

In the high-voltage battery, charge (regenerative braking) and discharge are alternately repeated.

Here, if the high-voltage battery outputs a maximum current that can be discharged and receives a maximum current that can be charged during generation and regenerative braking, the overall efficiency of the vehicle and the fuel efficiency can be improved.

FIG. 1 is a schematic diagram showing a drive system of a hybrid vehicle.

As shown in FIG. 1, the drive system includes an engine 10, a drive motor 11 for assisting the engine 10, and a battery 12 for charging and discharging electricity. The drive motor 11 and the battery 12 are electrically connected by a motor inverter 13 and a main relay 14.

Accordingly, the drive motor 11 and the battery 12 are operated in conjunction with each other by cooperative control of a motor controller 15 (motor control unit, MCU), a battery controller 16 (battery management system, BMS), an engine controller 17 (engine management system, EMS), and a vehicle controller 18 (hybrid control unit, HCU), and thus the charge and discharge operations of the battery 12 are achieved.

However, in the event of a failure of a component related to the control of the motor 11 such as the motor controller 15 in the hybrid vehicle, the probability of occurrence of safety accidents due to the battery would be increased.

For example, as shown in FIG. 2, since the system voltage is increased proportionally to motor RPM, a counter electromotive voltage due to a counter electromotive force of the motor is generated in the event of a failure of the motor controller, and thus the battery may be overcharged.

In the event of an overcharge, the battery controller performs an OFF control of a high-voltage relay to protect the battery; however, if the high-voltage relay is fused, the OFF control is not performed, and thus the risk of combustion and explosion exists due to the continuous overcharge.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides a method of protecting a battery for a hybrid vehicle, the method comprising: determining whether there is a failure in a main relay interposed between a battery and a motor inverter by determining whether the main relay is fused; determining whether there is a failure in the motor inverter, if it is determined that the main relay is fused; determining whether there is a failure in the battery by determining whether there is a risk of overcharge of the battery, if it is determined that there is a failure in the motor inverter; and controlling an upper limit engine speed to maintain a motor counter electromotive voltage at a sub-overcharge voltage, if it is determined that there is a failure in the battery, thus protecting the battery from the risk of overcharge.

Preferably, the determination of whether the main relay is fused may comprises: determining whether an initial charge relay is in an OFF state; comparing a battery voltage and an inverter voltage, if it determined that the initial charge relay is in the OFF state; and determining that the main relay is fused if a difference between the battery voltage and the inverter voltage is a predetermined value. In this case, for example, the comparison of the battery voltage and the inverter voltage may be performed by determining whether the inverter voltage is lower than 0.9 times the battery voltage.

Suitably, the determination of the risk of overcharge may be performed by determining whether there is an overvoltage on a battery cell, whether there is an over-temperature on a battery cell, or both.

In another aspect, the present invention provides a method of protecting a battery for a hybrid vehicle, the method comprising: determining whether communication of a motor controller is in an ON state or in an OFF state; determining whether communication of a battery controller is in an ON state or in an OFF state, if it is determined that the communication of the motor controller is in the OFF state; and controlling an upper limit engine speed to limit a motor counter electromotive force so as to maintain a motor counter electromotive voltage at a sub-overcharge voltage, if it is determined that the communication of the battery controller is in the OFF state, thus protecting the battery from a risk of overcharge.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a schematic diagram showing a drive system of a hybrid vehicle;

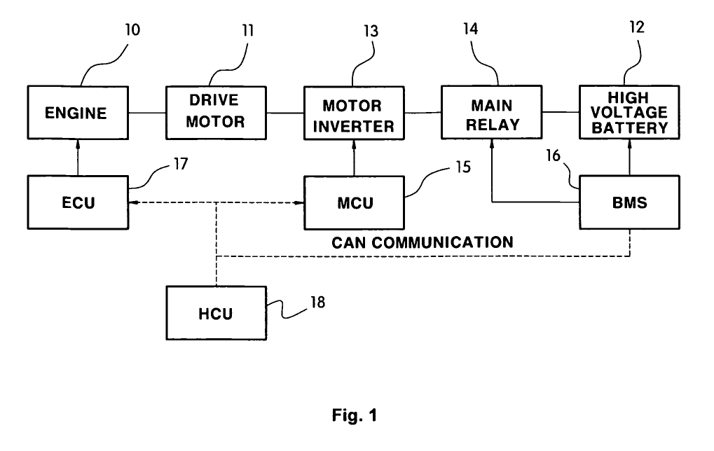

FIG. 2 is a schematic diagram showing the position of a main relay and a graph showing a relationship between engine RPM and system voltage in a hybrid vehicle;

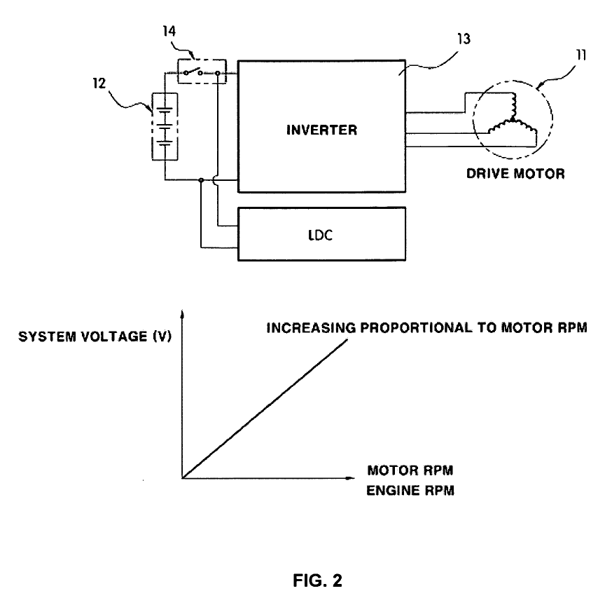

FIG. 3 is a schematic diagram showing a fused state of a main relay in a method of protecting a battery for a hybrid vehicle in a preferred embodiment of the present invention;

FIG. 4 is a flowchart showing a control process of determining whether the main relay is fused in the method of protecting a battery for a hybrid vehicle in accordance with the preferred embodiment of the present invention;

FIG. 5 is a flowchart showing the control process of the method of protecting a battery for a hybrid vehicle in accordance with the preferred embodiment of the present invention; and

FIG. 6 is a graph showing a relationship between engine RPM and counter electromotive voltage in the method of protecting a battery for a hybrid vehicle in accordance with the preferred embodiment of the present invention.

Reference numerals set forth in the Drawings includes reference to the following elements as further discussed below:

| | |
|---|---|
| 10: engine | 11: drive motor |
| 12: battery | 13: motor inverter |
| 14: main relay | |
| 15: motor controller (motor control unit, MCU) | |
| 16: battery controller (battery management | |
| system, BMS) | |
| 17: engine controller (engine management | |
| system, EMS) | |
| 18: vehicle controller (hybrid control unit, HCU) | |
| 19: initial charge relay | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

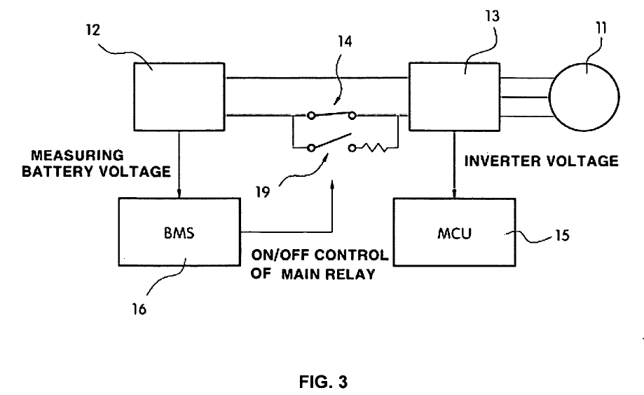

FIG. 3 is a schematic diagram showing a fused state of a main relay in a method of protecting a battery for a hybrid vehicle in a preferred embodiment of the present invention.

As shown in FIG. 3, an ON/OFF control of the main relay 14 is performed by a battery controller 16 and, in the event that the main relay 14 is fused, the OFF control by the battery controller 16 is impossible. Accordingly, in the event of a failure of a motor or a component related to the motor control, a counter electromotive voltage due to a counter electromotive force of the motor is generated according to engine RPM, and thus the battery may be overcharged.

Accordingly, the present invention provides a means for protecting the battery from the risk of overcharge and failure in the event that the main relay 14 is fused.

Reference number 11 denotes a motor, 12 denotes a high-voltage battery, 13 denotes a motor inverter, 15 denotes a motor controller, and 19 denotes an initial charge relay.

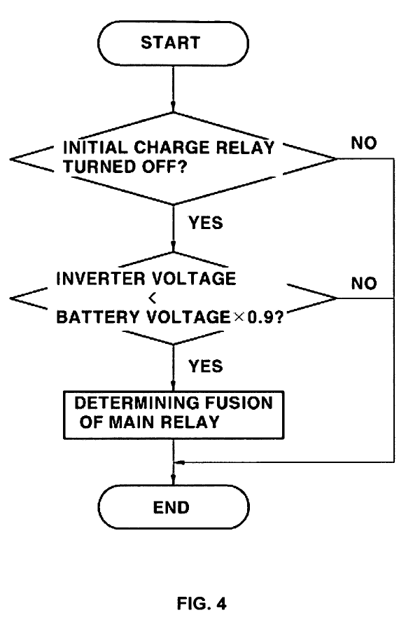

FIG. 4 is a flowchart showing a control process of determining whether the main relay is fused in the method of protecting a battery for a hybrid vehicle in accordance with the preferred embodiment of the present invention.

As shown in FIG. 4, the fusion of the main relay is determined by comparing a voltage output from the battery and a voltage output from the motor inverter.

That is, the fusion of the main relay is determined based on a relative difference between the battery voltage and the motor inverter voltage.

First, the battery voltage is measured by the battery controller and the motor inverter voltage is measured by the motor controller in a state where the initial charge relay is turned off.

Next, if there is no significant difference between the thus measured battery voltage and motor inverter voltage, e.g., if it satisfies a formula of inverter voltage<battery voltage×0.9, it is determined that the main relay is fused.

Here, the value of 0.9 means a range in which the inverter DC capacitor voltage drops minimally during fast key OFF/ON (about 300 msec). The value may be determined and changed by considering the discharge time of the inverter capacitor after Key OFF.

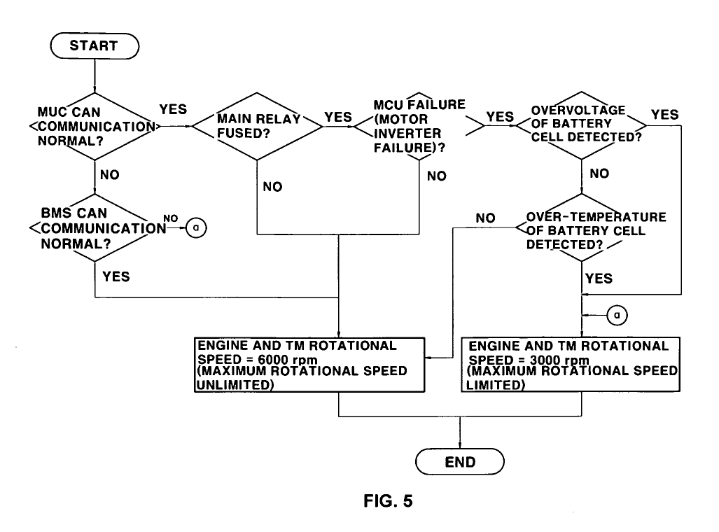

FIG. 5 is a flowchart showing the control process of the method of protecting a battery for a hybrid vehicle in accordance with the preferred embodiment of the present invention.

As shown in FIG. 5, in a state where a CAN communication of the motor controller is in a normal state, a failure of the main relay is determined by determining whether the main relay is fused.

The determination of the fusion of the main relay is performed based on a relative difference between the battery voltage and the motor inverter voltage as described above.

Next, if there is no failure (fusion) in the main relay, a control for limiting the engine RPM is not performed, i.e., an upper limit engine speed is not set. On the other hand, if there is a failure in the main relay, a process of determining whether there is a failure in the motor inverter is performed by the motor controller.

That is, if the motor controller cannot control the motor inverter due to a malfunction of sensors or a malfunction of hardware elements of the inverter, it is determined that there is a failure in the motor inverter. If the control of the motor inverter by the motor controller is possible, the control for limiting the engine RPM is also not performed.

Subsequently, in the event of the failure of the motor inverter, it is determined whether there is a risk of battery overcharge by the battery controller and, in the event of the risk of overcharge, a process of determining a failure of the battery is performed.

The failure of the battery may be determined by a method of detecting either or both a voltage of a battery cell and a temperature of the battery cell.

For example, it is determined whether the battery cell exceeds a predetermined voltage and, in the event of an overvoltage, the control for limiting the engine RPM is performed. Otherwise, it is determined whether the battery cell exceeds a predetermined temperature and, in the event of an over-temperature, the control for setting an upper limit engine speed is performed.

At this time, if the battery cell is not under the overvoltage or over-temperature condition, an upper limit engine speed is not set.

Otherwise, it is determined whether there is an overvoltage on the battery cell and, if there is no overvoltage, it is determined whether there is an over-temperature on the battery cell. If an over-temperature is detected, the control for setting an upper limit engine speed is performed.

Even in this case, if the battery cell is not under the overvoltage and over-temperature conditions, an upper limit engine speed is not set.

Here, any method of setting appropriate voltage and temperature of the battery cell, as is known in the art, may be used in the present invention.

As above, in the event of a failure of the battery, i.e., in the event of an overcharge, a process of protecting the battery from the risk of overcharge, in which an upper limit engine speed is controlled by an engine controller to maintain the motor counter electromotive voltage below an overcharge voltage, is performed.

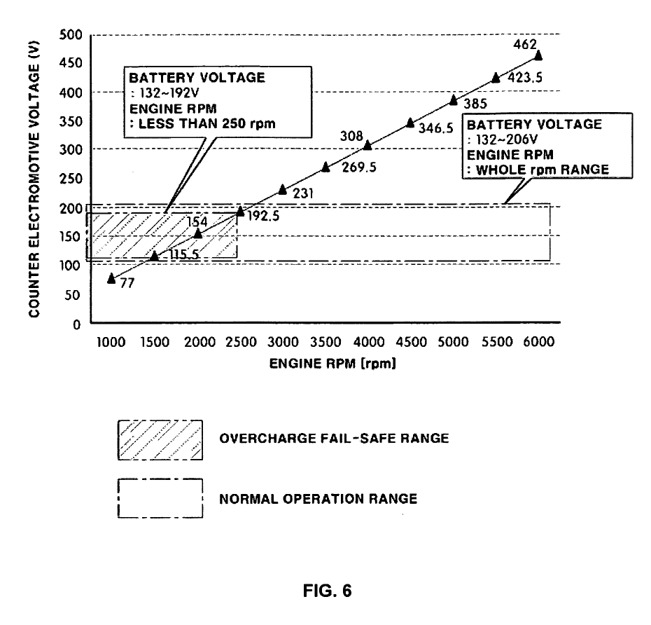

That is, as shown in FIG. 6, the engine is controlled by the engine controller to be within the overcharge fail-safe range, in which the battery voltage is in the range of 132 to 192 V and the engine RPM is 250 RPM or lower.

For example, if there is a risk of battery overcharge and the current engine rotational speed exceeds an upper limit engine speed, i.e., if it is out of the overcharge fail-safe range, the rotational speed of the engine is reduced by cutting off fuel supply to the engine.

Meanwhile, even in the event of a failure in the CAN communication between the respective controllers, the present invention provides a method of protecting the battery from the risk of overcharge.

For this purpose, a process of determining whether there is a failure in the CAN communication of the motor controller is first performed. If the CAN communication of the motor controller is in a normal state (turned on), the control process is performed by the above-described control logic. If the CAN communication of the motor controller is unavailable (turned off), a process of determining whether there is a failure in the CAN communication of the battery controller.

If the CAN communication of the battery controller is in a normal state (turned on), an upper limit engine speed is not set. On the other hand, if the CAN communication of the battery controller is unavailable (turned off), the control for setting an upper limit engine speed is performed to maintain the motor counter electromotive voltage below an overcharge voltage, thus protecting the battery from the risk of overcharge.

As described above, according to the method of protecting a battery for a hybrid vehicle provided by the present invention, in the event of a failure of a component related to motor control, especially, when the main relay is fused in the event of a failure of the motor controller, or when it is determined that there is a risk of battery overcharge by the battery controller in the event that the main relay is fused, the maximum engine RPM is limited to maintain the motor counter electromotive voltage below an overcharge voltage, thus protecting the battery from the risk of overcharge. As a result, it is possible to prevent safety accidents due to the battery in the event of a failure of various controllers such as the battery controller, motor controller, and vehicle controller.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of protecting a battery for a hybrid vehicle, the method comprising:
determining whether there is a failure in a main relay interposed between a battery and a motor inverter by determining whether the main relay is fused;
determining whether there is a failure in the motor inverter, if it is determined that the main relay is fused;
determining whether there is a failure in the battery by determining whether there is a risk of overcharge of the battery, if it is determined that there is a failure in the motor inverter; and
controlling an upper limit engine speed to maintain a motor counter electromotive voltage at a sub-overcharge voltage, if it is determined that there is a failure in the battery, thus protecting the battery from the risk of overcharge.

2. The method of claim 1, wherein the determination of whether the main relay is fused comprises:
determining whether an initial charge relay is in an OFF state;
comparing a battery voltage and an inverter voltage, if it determined that the initial charge relay is in the OFF state; and
determining that the main relay is fused if a difference between the battery voltage and the inverter voltage is a predetermined value.

3. The method of claim 2, wherein the comparison of the battery voltage and the inverter voltage is performed by determining whether the inverter voltage is lower than 0.9 times the battery voltage.

4. The method of claim 1, wherein the determination of the risk of overcharge is performed by determining whether there is an overvoltage on a battery cell.

5. The method of claim 1, wherein the determination of the risk of overcharge is performed by determining whether there is an over-temperature on a battery cell.

6. A method of protecting a battery for a hybrid vehicle, the method comprising:
determining whether communication of a motor controller is in an ON state or in an OFF state;
determining whether communication of a battery controller is in an ON state or in an OFF state, if it is determined that the communication of the motor controller is in the OFF state; and
controlling an upper limit engine speed to limit a motor counter electromotive force so as to maintain a motor counter electromotive voltage at a sub-overcharge voltage, if it is determined that the communication of the battery controller is in the OFF state, thus protecting the battery from a risk of overcharge.
